(19) United States
(12) Patent Application Publication
(10) Pub. No.: US 2014/0182296 A1
(43) Pub. Date: Jul. 3, 2014

(54) APPARATUS AND METHOD OF BURNING SEWAGE SLUDGE AND GENERATING POWER THEREOF

(71) Applicant: Tomer Zimmels, Haifa (IL)

(72) Inventors: Yoram Zimmels, Haifa (IL); Felix Kirzhner, Kiryat Yam (IL); Genady Borodyansky, Nesher (IL)

(21) Appl. No.: 12/303,746

(22) PCT Filed: May 30, 2007
(86) PCT No.: PCT/IL07/00655

§ 371 Date: Feb. 3, 2014

Related U.S. Application Data
(60) Provisional application No. 60/809,630, filed on May 30, 2006.

(51) Int. Cl. F23G 7/00; F02C 3/26; F23J 15/02; F23G 5/08

(52) U.S. Cl. CPC F23G 7/008; F23G 5/08; F02C 3/26; F23J 15/02
USPC 60/772; 110/238; 60/39.464; 110/215; 110/346; 110/345

(57) ABSTRACT

The disclosure is concerned with generating power using new organic fuel that is generated at wastewater purification plants in the form of sewage sludge with moisture content up to 90-95%. The world supplies this new orgabic fuel in very high quantites that are estimated to be more than 25-40 gr of dry mass/man/day. The new composite fuel comprises a coal suspension with the new dispersed medium, which is the liquid sewage sludge. The composite fuel is introduced into a furnace for combustion and generating power.

### FIELD OF THE INVENTION

The present invention relates to generating power using of new organic fuel. More particularly, the present invention relates to apparatus and method of sewage burning sludge and generating power from the sludge and coal.

### BACKGROUND OF THE INVENTION

Sewage sludge disposal is essential to protect public health. Using the sewage sludge for energy generation is even more desirable. Liquid sewage sludge disposal and usage as used nowadays is highly not cost effective since the liquids from the sewage sludge has to be dried, a process that is energy consuming.

It is a long felt need to provide a method for usage of liquid sewage sludge that is cost effective. The sewage sludge is to be used as a source of energy in a local prospective as well as universal.

### SUMMARY OF THE INVENTION

It is an object of the present invention to provide an apparatus for generating power using a new organic fuel. The power is generated at wastewater purification plants in the form of sewage sludge with moisture content up to 90-95%.

It is another object of the present invention to provide a power plant that is based on new composite fuel.

It is thus provided in accordance with a preferred embodiment of the present invention

An apparatus for burning sewage sludge using supplementary fuel comprising:
sewage sludge supply module;
fuel supply module;
mixer adapted to receive the sewage sludge from said sewage sludge module and fuel from said fuel supply module and form a mixture;
combustion module adapted to receive said mixture and form combustion.

Furthemore, in accordance with another preferred embodiment of the present invention, the fuel is coal in pulverized form.

Furthemore, in accordance with another preferred embodiment of the present invention, the fuel is mazut in an atomizied form.

Furthemore, in accordance with another preferred embodiment of the present invention, the apparatus is incorporated within a power generation plant wherein energy is generated from said combustion module.

Furthemore, in accordance with another preferred embodiment of the present invention, the fuel is liquid fuel such as mazut that is used in a form of fuel emulsion wherein said fuel emulsion is prepared in a gas turbine.

Furthemore, in accordance with another preferred embodiment of the present invention, the fuel is solid fuel such as coal or slurry that is used in its grinded form wherein said coal or slurry is grinded into powder with maximal sizes less 100 mkm that is used to prepare fuel suspension in a steam turbine.

Furthemore, in accordance with another preferred embodiment of the present invention, the embodiment further provided with plastificator from which elulsifying agents are delivered to said mixer.

Furthemore, in accordance with another preferred embodiment of the present invention, the sewage sludge comprises insoluble organic minerals, water, and solid components.

Furthemore, in accordance with another preferred embodiment of the present invention, the sewage sludge is delivered to said mixer through an ejector dozator.

Furthemore, in accordance with another preferred embodiment of the present invention, the fuel is delivered to said mixer through an ejector dozator.

Furthemore, in accordance with another preferred embodiment of the present invention, siad combustion module is provided with a filter adapted to filter exhaust gas.

Furthemore, in accordance with another preferred embodiment of the present invention, air compressor is provided adapted to compress air to said combustion module or to an ejector dozator that doze the fuel.

Furthemore, in accordance with another preferred embodiment of the present invention, said combustion module comprising gas turbine and furnace of steam boiler in seam turbine.

Furthemore, in accordance with another preferred embodiment of the present invention, said sewage sludge module and said fuel module are subsequent arranged and connected by conduit for pumping and dosing the fuel and the sewage sludge into siad mixer and wherein each of said sewage sludge module and said fuel module comprises an ejector and control valve as well as pumping modules connected by conduit perpendicular to an axis of the ejectors that are connected to the according modules.

Furthemore, in accordance with another preferred embodiment of the present invention, the apparatus further comprising atomizer through which said mixture is delivered to said combustion module, wherein said atomizer is provided with rotate pulverizing part to avoid slogging by solid particles inherent in the sewage sludge.

Furthemore, in accordance with another preferred embodiment of the present invention, the apparatus further comprising a block of cleaning combustion products for increasing power plant capacity when oxygen enriches and NOx-reduces and obtaining CO2 that is used as gas-ballast in said combustion module.

Furthemore, in accordance with another preferred embodiment of the present invention, said block of cleaning combustion products comprises water cooler connected to the block with thermal power station along stack gas side.

Furthemore, in accordance with another preferred embodiment of the present invention, said block of cleaning combustion products comprises bubble column filled with water to separate SO₂ from flue gas.

Furthemore, in accordance with another preferred embodiment of the present invention, said block of cleaning combustion products comprises thermal SO₂-degasator hydraulically coupled with said bubble column and said thermal SO₂-degasator supplied by heater for heating water by hot flue gas before entring into said cooler.

Furthemore, in accordance with another preferred embodiment of the present invention, said block of cleaning combustion products comprises bubble column filled with water to separate CO₂ from flue gas.

Furthemore, in accordance with another preferred embodiment of the present invention, said block of cleaning combustion products comprises thermal CO₂-degasator coupled with said bubble column and said thermal CO₂-degasator supplied by heater for heating of water by hot flue gas before entring into said cooler.

Furthemore, in accordance with another preferred embodiment of the present invention, said block of cleaning combustion products comprises an exit in which gas space of the thermal CO₂-degasator is connected with an entrance to said combustion module.

In addition and in accordance with yet another preferred emdediment of the present invention, it is provided a method for burning sewage sludge comprising:
dispersing said sewage sludge into finely pulverized sewage sludge form in a mixer;
mixing said finely pulverized sewage sludge with fuel into a mixture;
adding plastificator into said mixture to form a stable mix;
introducing said stable mix into a combustion module;
burning said stable mix in said combustion module.

Furthemore, in accordance with another preferred embodiment of the present invention, the method further comprising generating power from said said combustion module.

Furthemore, in accordance with another preferred embodiment of the present invention, wherein said combustion module comprising gas turbine and furnace of steam boiler in seam turbine.

Furthemore, in accordance with another preferred embodiment of the present invention, the sewage sludge is used in simple cycles of thermal power generation.

Furthemore, in accordance with another preferred embodiment of the present invention, the sewage sludge is used in combine cycles of thermal power generation.

Furthemore, in accordance with another preferred embodiment of the present invention, the method further comprising pumping primary air necessary to burn the sewage sludge into said fuel and pumping secondary air into said combustion module.

Furthemore, in accordance with another preferred embodiment of the present invention, the method further comprising selecting the sewage sludge to fuel ratio to be not more than 0.5.

Furthemore, in accordance with another preferred embodiment of the present invention, the method further comprising refining the ratio between sewage sludge and fuel in accordance with demand of NOx-reducing up to level less than 10 ppm under simultanuos providing stable combustion between 100% to 30% load.

Furthemore, in accordance with another preferred embodiment of the present invention, the method further comprising providing atomizer that introduces sad stable mix into said combustion module, wherein said atomizer is provided with rotate pulverizing part to avoid slogging by solid particles inherent in the sewage sludge.

Furthemore, in accordance with another preferred embodiment of the present invention, the method further comprising impriving the stability of combustion by oxygen enrichment through membrane gas generator that is adapted to connect an exhaust gas outlet with an entrance of siad combustion module.

Furthemore, in accordance with another preferred embodiment of the present invention, the method further comprising simultaneously improving stability of suspension or emulsion that is delivered into said combustion module.

Furthemore, in accordance with another preferred embodiment of the present invention, the method further comprising providing block of cleaning combustion products for increasing power plant capacity when oxygen enriches and NOx-reduces, and obtaining CO2 that is used as gas-ballast in said combustion module from siad block of cleaning combustion products.

Furthemore, in accordance with another preferred embodiment of the present invention, wherein said block of cleaning combustion products comprises water cooler connected to the block with thermal power station along stack gas side.

Furthemore, in accordance with another preferred embodiment of the present invention, said block of cleaning combustion products comprises bubble column filled with water to separate SO₂ from flue gas.

Furthemore, in accordance with another preferred embodiment of the present invention, said block of cleaning combustion products comprises thermal SO₂-degasator hydraulically coupled with said bubble column and said thermal SO₂-degasator supplied by heater for heating water by hot flue gas before entring into said cooler.

Furthemore, in accordance with another preferred embodiment of the present invention, said block of cleaning combustion products comprises bubble column filled with water to separate CO₂ from flue gas.

Furthemore, in accordance with another preferred embodiment of the present invention, said block of cleaning combustion products comprises thermal CO₂-degasator coupled with said bubble column and said thermal CO₂-degasator supplied by heater for heating of water by hot flue gas before entring into said cooler.

In additi and in accordance with another preferred embodiment of the present invention, said block of cleaning combustion products comprises an exit in which gas space of the thermal CO₂-degasator is connected with an entrance to said combustion module.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a burning sludge apparatus in accordance with a preferred embodiment of the present invention.

FIG. 2 illustrates a schematic flow diagram of the system and method of burning sludge and fuel in accordance with a preferred embodiment of the present invention.

FIG. 3 illustrates a mass balance flow chart of the burning process in accordance with a preferred embodiment of the present invention.

FIG. 4 illustrates an energy balance flow chart of the burning process in accordance with a preferred embodiment of the present invention.

FIG. 5 illustrates a technological scheme of a power plant of combine cycle in accordance with another preferred embodiment of the present invention.

FIG. 6 illustrates a stack gas cleaning unit in accordance with a preferred embodiment of the present invention.

### DETAILED DESCRIPTION OF THE INVENTION AND FIGURES

The present invention provides a power plant with new composite fuel. The new composite fuel is preferably based on coal suspension or not, then oil emulsion with a new disperse medium—the liquid sewage sludge. In case of using oil emulsion, the liquid sewage sludge in the new composite fuel will be in a disperse phase. The composite fuel of the present invention, whether dispersion or emulsion, is introduced into a furnace for combustion by means of an atomizer. The present invention eliminates the drawbacks of the prior devices mentioned herein-above, and renders possible combustion of finely distributed dispersion, or pulverization, of highly wet sewage sludge.

A unique feature of the composite fuel of the present invention is its relatively high moisture content, having usually low kind coals and coal wastes—slurry, a feature that inhibits its use in power generation by usual and conventional methods. The inventors of the present invention have developed unique method for preparing the fuel and its use in order to generate power.

The composite fuel in accordance with one aspect of the present invention contains 70% low calorifical and high wet coal—slurry of, for example, wetness W=17%, heat Q=14.4 MJ/kg of working mass, and 30% of liquid sewage sludge with wetness of W=90% and heat value Q=17 MJ/kg of dry mass having heat value 11.31 MJ/kg of composite fuel—suspension and wetness 38.9%, on evaporation of which the certain amount of power (0.87 MJ/kg of composite fuel) would be expended and effective heat value of composite fuel 10.44 MJ/kg of composite fuel. For comparison, part of heat value of composite fuel related to coal is 10.8 MJ/kg of composite fuel

A plant in accordance with a preferred embodiment of the present invention comprises the following equipment, as will be shown and elaborated herein after:

pulverizing mill,

mixer for preparing water-coal suspension,

water-coal suspension supplier into a furnace,

pulverized coal atomizer,

furnace,

turbogenerator,

ash collection system,

output gas filter.

A process of burning liquid sewage sludge is initiated by immediate burn up of mixes of liquid sewage sludge/oil emulsion or liquid sewage sludge/coal suspension that is preliminary prepared. Then, one of the mixes or both are introduced into the furnace for combustion by means of an atomizer.

The total continuous working process consists of 6 stages:

a. introducing the fuels into mix-preparating zone,
b. introducing sewage sludge into the mix-preparating zone,
c. dispersing and mixing the fuel and the sewage sludge in a mix-preparating zone,
d. pumping the prepared fuel mix into a combustion zone,
e. burning the fuel mix in the combustion zone, and
f. discharging the exhaust gas to the atmosphere.

During the process of combustion, the sewage sludge is transformed into ash and gas combustion products from which power can be generated.

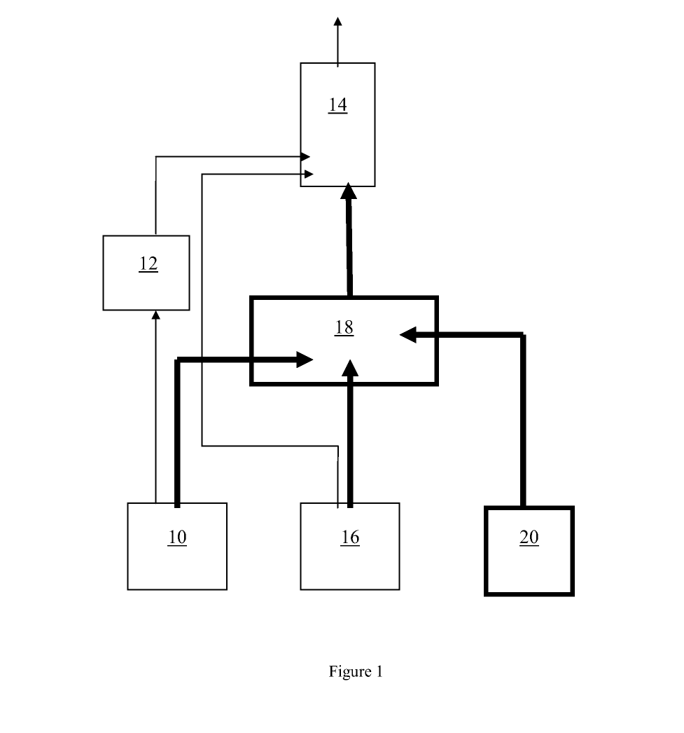

Reference is made to FIG. 1 illustrating a burning sludge apparatus in accordance with a preferred embodiment of the present invention. The inovative features of the method of the present invention are highlighted in the figure in compared to the prior art. Basically, in accordance with prior art burning of sewage sludge, sewage slugde 10 is instruduced into a drier 12 where the sludge is dried in relatively high cost equipment and a process that is energy consuming. Then, the dried sewage sludge introduced into a furnace 14 where it is combusted. Fuel 16 is being transferred into furnace 14 for the combustion process. The prior art is indicated in this figure in thin lines and arrows while the new features in the new invention are indicated by bold lines and arrows. According to the new and unique apparatus and method of the present invention, fine disperse blend is prepared in a mixer 18 that receives solid or liquid fossil fuel (in a disperse phase) 16 and liquid sewage sludge 10 preferably in a disperse medium with humidity up to 95-99%. Stability is imparted to the emulsion by means of emulsifying agent delivered from plastification tank 20. In this process, the prepared mix can comprise suspension of fuel (if solid fuel is used, the form will be coal), reverse emulsion of pulverized water in fuel (if liquid fuel is used, the form will be oil), suspension of sewage sludge (if solid phase elements are present, for example cellulose, in the sewage sludge composition), emulsion of sewage sludge (if there are, for example, fats in the sewage sludge composition).

The scientific base of the method invented by the inventors of the present invneiotn lies in preparation and burning of water-coal blends—soles, and also water—oil blends—emulsions. It is possible to prepare an emulsion and to construct a mixer on the base of electro-hydraulic effect [Eric C. Cottell, Combustion Method and Apparatus Burning an Intimate Emulsion of Fuel and Water, U.S. Pat. No. 3,749,318, US Cl. 239/102˜Jul. 31, 1973].

The novelty of the disperse system invented by the inventors of the present invention in contrast to traditional water/fuel blends is in the presence of an additional dispersed phase of admixtures entering into the sewage sludge composition. The water content in the sewage sludge is defined by the dispersed phase in the disperse system. The presence of this phase in a fine dispersed form renders the possibility to obtain its reverse emulsion in a mixer-dissertator that is pumped by centrifugal atomizer to the furnace (disk rotational speed 8000-10000 rpm). Micro-explosions that occur in this fine dispersed phase, which is in the shape of droplets (that take place because of the boiling temperature of water, which is 100° C., while the boiling temperature of oil is 300° C.) create conditions for further crushing of the fuel and top-quality and low emission combustion. The organic content (heat value of 13-19 MJ/kg of dry mass) of sewage sludge is completely burnt in the furnace.

As an estimation, 140,000 tons/year dry mass of sewage sludge are forecasted in Israel for the year 2007; that is, about 700,000 tons/year of liquid sewage sludge for preparation of 3,500,000 sewage sludge/fuel emulsion that permits not only to dispose sewage sludge but also to improve burning of fuel in order to generate power. From the ecological standpoint, the process of the present invention reduces the harmful pollutions, among them—NOx. Though in this process, the evaporation of wet fuel accounts for consumption of energy (about 1.7% of oil in its 30% humidity).

In a specific example, the fuel that is used is oil, the emulsion is reverse emulsion (water/oil), the emulsifying agent is surface-active substance, which sustains emulsions with oil as disperse medium, that is, in its reverse state. Emulgators of this sort are high-molecular surface-active substances, having tendency to dissolve in fat-like disperse medium (e.g. hydrocarbons) to a greater extent than in water, that is have the greater affinity to oil than to water.

Optionally, the necessary reverse emulsions can be obtained from lipophilic surface-active substances having HLB (hydrophilic-lipophilic balance) in the range of 3-6. These substances are not soluble in water, but are well soluble in hydrocarbons, for example, rubber and other high polymer compounds that are soluble in hydrocarbons (oils). The nafta-tar and asphaltens are examples of natural emulsifying agents inherent in crude oil.

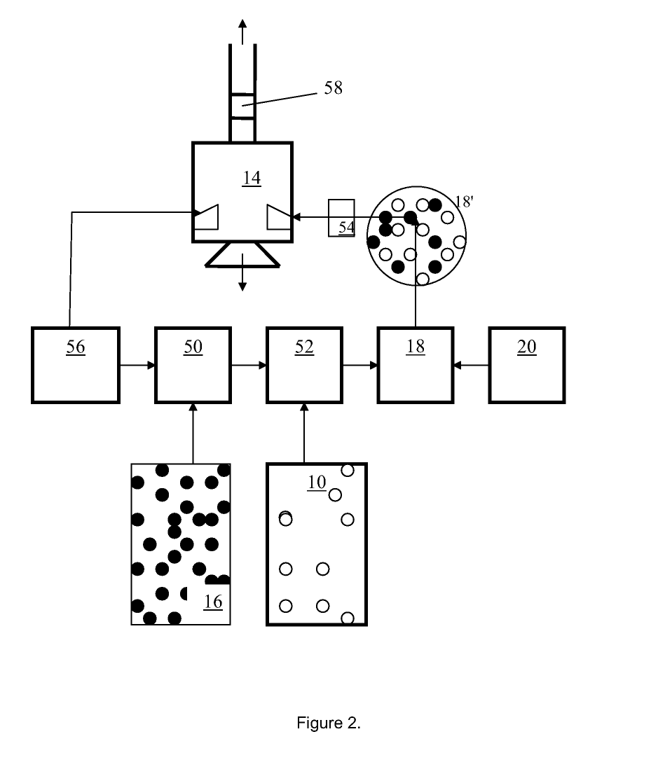

Reference is now made to FIG. 2 illustrating a schematic flow diagram of the system and method of burning sludge and fuel in accordance with a preferred embodiment of the present invention. This diagram is an elaborated apparatus that is optionally based on the features shown in FIG. 1. The apparatus and method in accordance with the present invention comprises the following:
a. introducing fuel, which optionally can be pulverized coal of 200-500 mkm, from tank 16 into the mixing zone 18 through an ejector dozator fuel 50 and ejector dozator liquid 52;
b. introducing sewage sludge from tank 10 into mixing zone 18 through ejector dozator liquid 52. The sewage sludge preferably comprises Insoluble organic & minerals (1-5%), water, soludle organic & minerals, and solid components;
c. dispersing sewage sludge 10 in finely pulverizing form in a mix-preparinging module;
d. preparing the finely pulverizing sewage sludge/fuel mix (emulsion or suspension);
e. adding plastificator 20 into the resulting mixture. If necessary, the platification agent is in an amount necessary to improve the stability of the mixture;
f. introducing the obtained mix 18′ from mixer 18 into a combustion module; the combustion module is optionally comprises a furnace 14 into which mix 18′ is pumped by a pump 54. Air compressor 56 that transfers air to furnace 14 is contributing to the burning process. Primary air is compressed directly to the combustion module while it is optional to compress primary air to ejector dozator fuel 52.

A filter 58 is optionally provided to the exhaust of furnace 14 and ash is discharhed preferably from the bottom of the furnace.

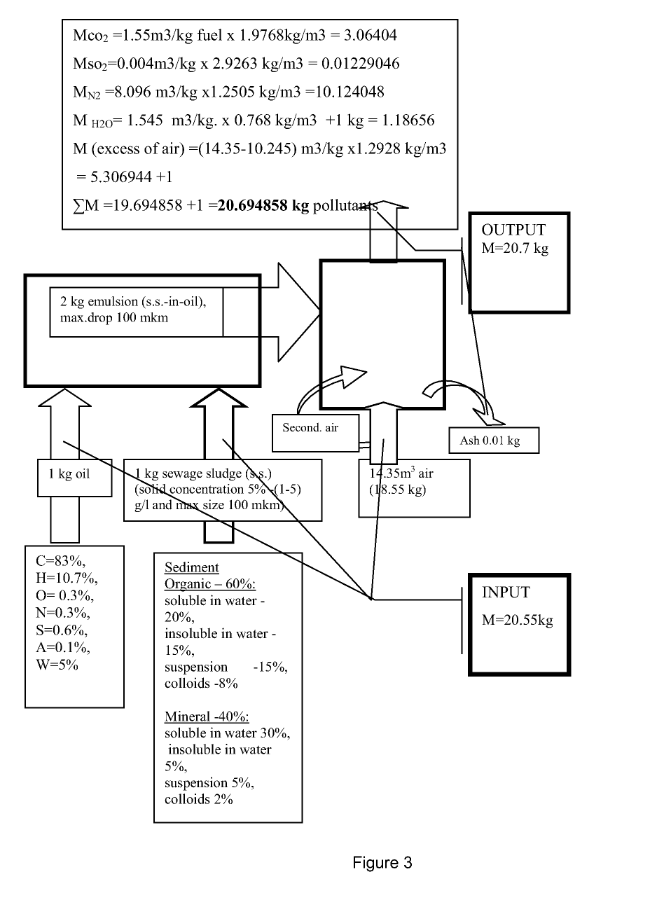

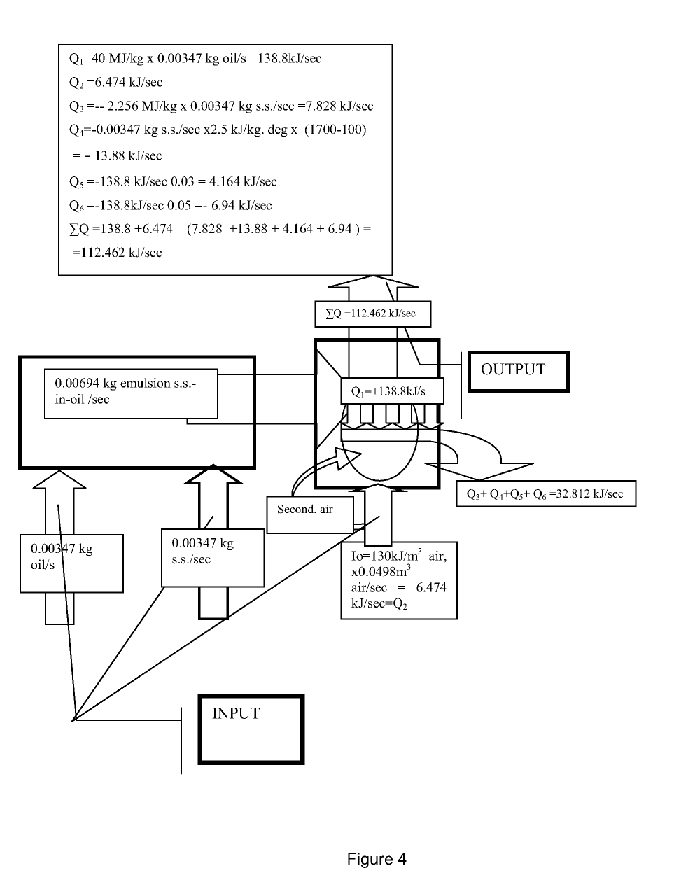

Reference is now made to FIGS. 3 and 4 illustrating a mass balance flow chart of the burning process in accordance with a preferred embodiment of the present invention. The quantities and values given in the figures are examplary and are indicated solely for illustrative purposes.

### Preparation of Emulsion

The inventors of the present invention consider the process of emulsification as a process of mixing two immixing liquids: sewage sludge (water) and mazut (oil).

In accordance with one aspect of the present invention, ultrasonic technology is realized in ultrasonic generator-reactor—a device resembling a long, slim electric motor. It contains a crystal stack at one end and a mixing chamber at the other. When a voltage of 50-Hz is applied, the crystals vibrate at 20,000 Hz, turning the reactor into a “super-blender”. Oil and water (70% oil, 30% water) flow into the reactor, where a terrific vibrating force causes water and oil molecules to rupture. The two liquids form an emulsion in which tiny particles of water are dispersed throughout the oil. When this happens, the surface area of the water is increased in millions times. Thus, when the emulsion hits the furnace's combustion chamber, the water “explodes” into superheated steam, adding to the energy output of the oil.

It is an important advantage of this technology that it is not necessary to use any emulsifying agent, particularly when sonic emulsification is used.

Analysis of the inventors shows that cavitational (hydrodynamic) technology is a best suited method to mix the liquids—sewage sludge (water) and mazut (oil). This is in accordance with a second aspect of the present invention. There are many smallest-sized bubbles of gas or vapor in sewage sludge as well as in oil that move together while flowing. However, while flowing, local reduction of pressure, for example, may occur, where velocity is increased. This results in reduction of pressure to a region of low pressure which is lower than the pressure of saturated vapor p<pₖₚ. Bubbles growing and liquid boiling generate large number of cavitational small-sized bubbles (cold boiling). The volume concentration of cavitational bubbles is equal 1×10¹⁰ Ha 1/M³.

After these bubbles are transferred from low pressure zone to high pressure zone, their growth is stopped and they begin to collapse. Collapse of every bubble causes the velocity of cumulative stream to reach 700 M/C. In this process, impulse of pressure to 10³ M [symbol] a (10⁴ atm) is generated while accompanied by temperature increase up to 500-800 C in zone of collapsed bubbles.

So, in initial stages, the pressure (p) in cavitational water vapor bubbles is higher than the pressure in liquid water drop and oil (pₑ). But then, as the pressure of water vapor in the bubble is increased due to evaporation, the bubbles are growing.

In final stages, the pressure (p) in cavitational water vapor bubbles sharply falls, practically to 0. The envelope of the bubble losses its stability, liquid dushes to the center of the bubble and it collapses. In the center of the bubble, the cumulative streams are obtained with large density (concentration) of energy. These are precisely cumulative streams that will intensify a mixing and dispergating of water in water-in-oil emulsion.

Hydrodynamic cavitation is generated in rotor mixers [19] but the suggested technology of mixing is based on an idea of using jet pumping, that is free from rotative parts.

### Burning of Emulsion

Since the boiling temperature of water is lower than the boiling temperature of oil and oil acts as heat isolator for water drops, water inside the drops is superheated. Then, the water boils and collapse to finely divided parts (micro explosions of drops). These micro explosions are favorable to intensification of heat and mass-transfer. This feature is connected to imperfection of atomizers that do not permit supply of liquid fuel dispergation to less than 100 mkm. Some manufactures uses increased pump pressure and smaller nozzle size to increase atomization and burning efficiency.

However, when water in oil emulsion enters an atomizer, every drop of this emulsion contains few thousands of water micro drops. When they are exploded, the secondary dispergating of oil takes place in the combustor in result of the micro explosions of water drops with bubbles. This results in increased turbulence pulsations, increased torch volume, equalized temperature field, decreased local maximal temperatures and as eventually, the drastic reduction of NOx-generation so that there is no longer necessary to employ other additional methods of NOx-reduction.

As mentioned herein before, a device for carrying out the method according to the present invention comprises a combustion module. The combustion module further comprises:

appliance for pumping and dosage of oil and sewage sludge introduced into combustion module for each mixed liquid (sewage sludge and oil),
appliance for pulverizing of the sewage sludge in the sewage sludge tank, said sludge pulverizing means being,
and appliance for controlling of the volume composition of the mixed components going out from the fuel and sewage sludge tanks.

According to the method of the present invention, in a preliminary phase, pulverizing and mixing of sludge and oil are prefereably made by means of cold boiling, that is, cavitation. Preferably, this stage takes place in a dispergator-emulgator.

Then, igniting the auxiliary burner enables the mean combustion temperature to be raised to a value high enough to initiate the operation of the main burner when the latter are fed. When the mean temperature in the combustion chamber is stabilized at a value of about 850 C., the useful operating phase is started by injecting and pulverizing of sludge by means of the atomizer. Secondary pulverizing by means of “hot boiling” of water drops and its micro explosions takes place.

The resulting products of the sewage sludge burning are evacuated together with the combustion products resulting from the burning of the fuel fed to the burners. When the sludge contains combustible substances, especially hydrocarbons, the latter contribute to the combustion, whereby the gas consumption of the device is reduced.

A suggested device according to the invention is adapted to operate in a most satisfactory, continuous manner with a perfectly favorable energetic balance, producing excellent economic results. The invention is not limited to the embodiments shown and described herein. Those skilled in the art may envisage numerous variants and modifications without departing from the spirit and scope of the invention as defined in the appended claims.

### Utilization of Burning Heat

Effectivity of sewage sludge burning may be improved significantly if it is looked on as energy systems that produce combined heat and power (CHP) producing heat and electricity for their own needs, from a unique source, generally using both forms of energy. In this case, electricity is not exported and its capacities are between 0.03 MWe and 0.5 MWe.

The conversion of fuel to electricity in a conventional power generation system is usually only 30-40% efficient. Up to 70% of the energy potential is released as waste heat. Therefore, overall energy savings of between 20% and 40% are achievable in this way. An overall efficiency of 80% is achievable with CHP. And direct savings in electricity costs are therefore possible. Typically, a small-scale unit converts about 30% of the input energy to electricity (MWe) and 50% to useful heat (MWth).

Cogeneration systems, include: an engine which drives an electricity generator, a generator, which produces the electricity; a heat recovery system, to recover the waste heat from the engine, a control system, an exhaust system, and an acoustic enclosure.

Cleaning the Exhaust from SO2 and CO2

In contrast to classic thermal power plant, combustion waste gas is not desulfurized and denitrificated in corresponding cleaning units but enters heat exchanger (cooler) and, after reaching the request temperature there, enters the dissolving block. In the apparatus of the present invention, a block for cleaning the combustion products is provided wherein inside the block, individual components of stack gas are dissolved in corresponding, for every component in a bubble column. Due to this dissolvment, gas composition at the exit of the block differs from the one at the entrance.

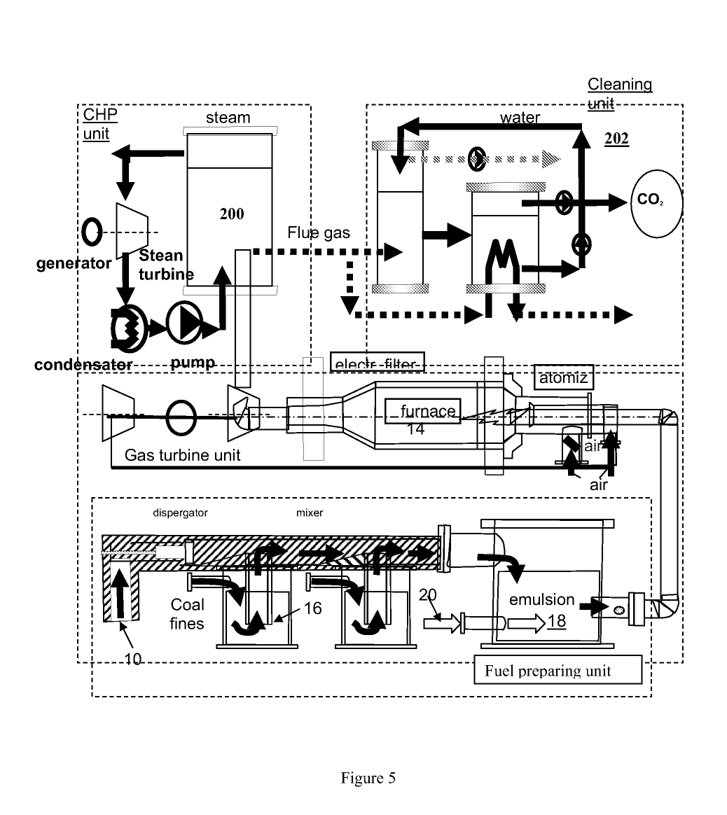

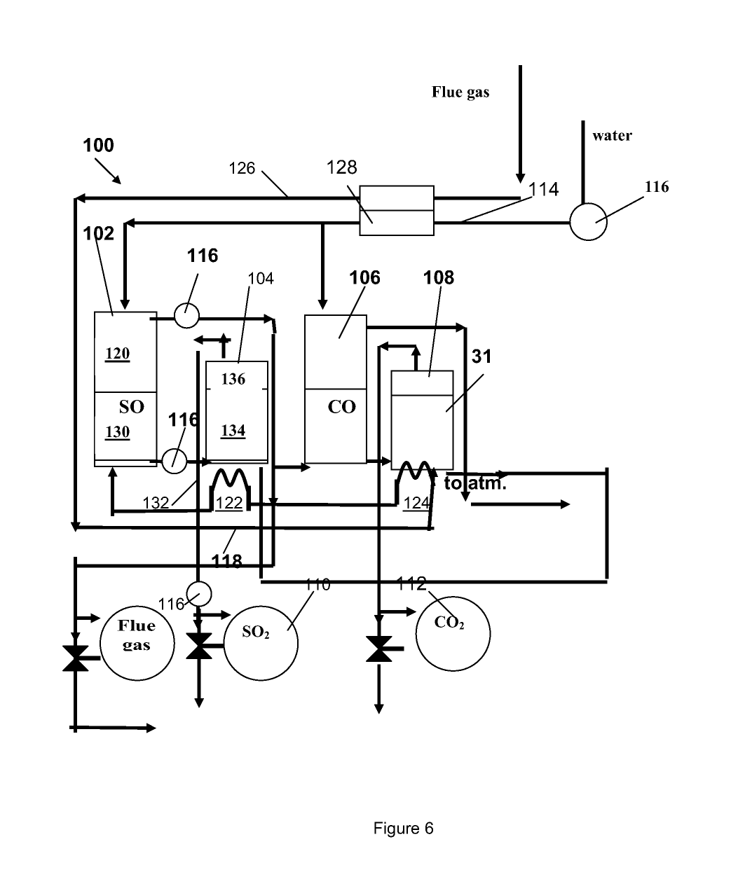

Reference is now made to FIGS. 5 and 6 illustrating, respecituvely, a technological scheme of a power plant of combined cycle in accordance with preferred embodiment of the present invention and a stack gas cleaning unit in accordance with a preferred embodiment of the present invention. FIG. 5 has the basic components as shown in FIG. 1, however, FIG. 5 illustrates the apparatus in more details including a cleaning unit 202.

The typical composition of stack gas at the entrance of the block 100 (FIG. 6):

[N₂]=85%=0.85 l/l,[CO₂]=12.5%=0.125 l/l,[O₂]=2.5%=0.025 l/l,[SO₂]=0.01%=0.0001 l/l,[NO]=0.01%=0.0001 l/l.

Block 100 comprises tube columns with cascade connection filled with water 102, 104, 106 and 108.

The solubility of these gas components in water at P=1 bar a T=20° C. are as follows:

(N2)*=15.4 ml/l H₂O;(CO₂)*=878 ml/l H₂O;(O₂)*=31 ml/l H₂O;(SO₂)*=76 l/l H₂O;(NO)*=46 ml/l H₂O;

But at partial pressures: P_{N2}=0.85 bar; P_{CO2}=0.125 bar; P_{O2}=0.025 bar; P_{SO2}=0.0001 bar; P_{NO}=0.0001 bar, the corresponding solubilities will be as follow:

(N₂)*=13.09 ml/l H₂O;(CO₂)*=107.75 ml/l H₂O;(O₂)*=0.775 μl/l H₂O;(SO₂)*=7.6 ml/l H₂O;(NO)*=0.0046 ml/l H₂O.

However it will be better to introduce the relative solubility of every component in real stack gas as follow:

(N₂)*/[N₂]=13.09/850=0.0154 l st.g./l H₂O;

(CO₂)*/[CO₂]=109.75/125=0.878 l st.g./l H₂O;

(O₂)*/[O₂]=0.775/25=0.031 l st.g./l H₂O;

(SO₂)*/[SO₂]=7.6/0.1=76 l st.g./l H₂O;(NO)*/[NO]=0.0046/0.1=0.046 l st.g./l H₂O;

where numerator shows how much one component can dissolve in 1 liter H₂O and denominator shows how much of one component should dissolve per 1 liter of stack gas.

One can see that firstly one should dissolve component SO₂ in block 100 because it is an easier process. It is made in first tube column 102 of block 100.

Further calculations are made for one volume unit of stack gas—1 liter/s entering to column 102 and containing 0.1 ml SO₂. Then 0.1/7.6=0.0132 l. H₂O/1 liter st.g. is sufficient to dissolve this amount of SO₂. At the same time, one can see that dissolving appreciably the rest of the components in that small amount of water is impossible. So, in column 102 there are good conditions for SO₂ dissolution under water flow rate 0.0132 l H₂O/l st.g.

After passing the column 102, chemical composition of stack gas practically does not change, only [SO₂]=0.

[N₂]′=85%=0.85 l/l;[CO₂]′=12.5%=0.125 l/l;[O₂]′=2.5%=0.025 l/l;[NO]′=0.01%=0.0001 l/l.

Such is the composition of stack gas at the entrance of second column 106. The next component on solubility is CO₂ and dissolving of CO₂ takes place in dissolving column 106.

As in the earlier stage, one can calculate the parametres of column 106 for one volume unit of stack gas—1 liter/s entering to the column and containing 125 ml CO₂. Then 125/109.75=1.139 l H₂O/l st.g. is sufficient to dissolve this amount (125 ml) CO₂. So, in second dissolving column 106 there are suitable conditions for CO₂— dissolving at water flow rate of 1.139 l H₂O/l st.g. At the same time, one can see that dissolution of the other components in the column, because their low solubility, is impossible. After passing of the second column 106, the chemical composition of stack gas changes essentially

[CO₂]″=0.125 l/l−0.125 l/l=0

[N₂]″=0.85 l/l−0.01309 l/lH₂O×1.139 l H₂O/l st.g=0.85−0.015=835 ml/l,

[O₂]″=0.025 l/l−0.775 ml/l H₂O×1.139 l H₂O/l st.g=0.025−0.0009−24.1 ml/l,

[NO]″=0.1 ml/l−0.0046 ml/l H₂O×1.139 l H₂O/l st.g=0.1−0.005=0.095 ml/l.

So now, the chemical composition is as follow:

[N₂]+[O₂]+[NO]=835+24.1+0.095=859,195 ml(100%),

[N₂]″=835/859,195=0.972{97.2%},

[O₂]″=24.1/859,195=0.028{2.8%},[NO]=0.0001{0.01%},

or on 1 liter of stack gas base: [N₂]=972 ml/l st.g., [O₂]=28 ml/l st.g., [NO]=0.1 ml/l st.g.

Stack gas of this composition comes out from dissolving column 106 at corresponding parlial pressures solubilities of the other components:

(N₂)″=15.4 ml/l H₂O×0.972=14.97 ml/l H₂O,(O₂)=31 ml/l H₂O×0.028=0.868 ml/l H₂O,

(NO)″=46 ml/l H₂O×0.0001=0.0046 ml/l H₂O

And, as herein before, the relative solubilities are calculated as follows:

S_{N2}=(N₂)/[N₂]=14.97/835=0.0179,S_{O2}=(O₂)/[O₂]=0.868/28=0.031,

S_{NO}=(NO)/[NO]=0.0046/0.1=0.046

One can see that the relative solubilities of component N₂, O₂, NO coming out of column 106 are very close and therefore further separation of gas mixture is very difficult.

Practically, after passing column 106, the chemical composition of the stack gas is close to pure N₂ (˜97%). So, flue gas is separated by separator on individual components SO₂ (column 102, water solution), CO₂ (column 106, water solution), N₂ (gas phase, gas space of column 106).

The output of separation block 100 is N₂ pure (gas phase); other components are in water solutions.

One can convert components (SO₂, CO₂) also to the gas phase. For this purpose, at the same time of dissolving SO₂ (in column 102) and CO₂ (in column 106) corresponding solutions direct to thermal degasators 104 and 108 accordingly. These degasators are supplied with heaters operating with hot waste gas from power station. Heating of water in degasators 104 and 108 permits the escape of SO and CO₂ accordingly from aqueous solution to gas phase above water surface. Further, every component is pumped to its own storage tank —110 for SO₂ and 112 for CO₂.

At least one but more gas cleaning blocks 100 can be provided, each is destinated to cleaning stack gas from one of the gas component (SO₂, CO₂) reservoirs 110 and 112 for storage of separated gas components, pipe-lines of water 114, cleaned gas and noncleaned gas pipes, transfer pumps 116 providing a transfering of water and gas along the apparatus.

Each of gas cleaning blocks, in its turn, consists of bubble columns, filled by running water, destinated for dissolving one of components of stack gas in water, thermal degasator, and destinated for elimination (releasing) of dissolved component from the running water.

Each of the gas cleaning blocks is in series communicating with one another through the bubble column by means of cleaned gas pipe-line 118, that is, gas space 120 of the bubble column of previous gas cleaning block connected by pipe-line with the entrance to the bubble column of the next block.

Thermal degasators 104 and 108 are supplied by plain-tube coil 122 and 124, respectively for passing and cooling hot non-cleaned stack gas before entering into bubble column 102.

The cleaning block is operated in the following manner: after the fuel-burning module such as furnace of boiler 200 (FIG. 5), stack gas is transferred to a cleaning unit 202 pass preferably through smoke fan along pipe-line 126, water cooler 128 and through plain-tube coil 122 and 124 is derived into water space 130 of bubble column 102 of gas cleaning block 100. Water space 130 is filled by running water, flow rate of which is determined by the SO2-content in the stack gas, flow rate of stack gas and SO2-solubility in water at given temperature. Filling and maintenance of the rated level is realized by pumps pipe-line 114.

The stack gas, have cleaned from the dissolved (in water) SO₂ arrives into gas space 120 and further along the pipe-line by means of pump 106 is directed into a pond for microalgae outdoor cultivation through the pipe-line 118, or into a gas cleaning block for further cleaning.

The aerated water with SO2 dissolved from water space 130 along pipe-line 132 is discharged by pump 116 into water space 134 of thermal degasator 104. Here, the heating of ater takes place by heat of noncleansed stack gas through the plain-tube coil 122 fitted into thermal degasator. This heating causes the degasation of water and SO₂-releasing into gas space 136 of the degasator. From this gas space, the released gas SO₂ is directed by a pump along the pipe-line into ballon 110. The purified (from SO₂) water is returned by a pump along pipe-line into water source for cooling.

In each successive gas cleaning block, the process of gas cleaning goes on in a similar manner. However, the sizes of the blocks and flow rates of water are determined for each block by the solubility characteristics of the components that are to be dissolves in the block and the content of the specific component in the stack gas (in the case that is drawn in FIG. 6, CO₂ is that necessary component). An example of main characteristics of the new composite fuel of the present invention are depicted in Table 1. It should be noted that this composition is exemplary and by no means limits the scope of the present invention.

TABLE 1

| | | | | | | | Q° |
|---|---|---|---|---|---|---|---|
| | W° % | A° % | S° % | C° % | H° % | N° % | MJ/kg |
| Mazut | 3 | 0.05 | 0.3 | 84.65 | 11.7 | 0.3 | 40.28 |
| Related to | | | 0.7 | 87.8 | 10.7 | 0.8 | |
| combustible mass | | | | | | | |
| (c) | | | | | | | |
| Sewage sludge | 95 | 9 | 0.7 | | | | 17 |
| Solid sediment of | | | | | | | |
| sewage sludge | | | | | | | |

| | |
|---|---|
| Solid/liquid | 5% |
| organic content | 60% |
| soluble in water | 20% |
| insoluble | 15% |
| suspension | 15% |
| colloids | 8% |
| mineral | 40% |
| soluble in water | 30% |
| insoluble | 15% |
| suspension | 5% |
| colloids | 2% |

The main technological parameters of the process of burning sewage sludge are shown in Table 2 below (as an example):

| | | | |
|---|---|---|---|
| 1 | Amount of municipal | kg/man · day | 0.5-0.8 kg |
| | sewage sludge on | | wet/man.day |
| | 1 man/day | | 0.025-0.04 kg |
| | | | dry/man · day |
| 2 | Wetness after primary | % | 92-97% |
| | treatment | | |
| 3 | Dispersity of emulsion | mkm | 5-25 mkm |

| | | |
|---|---|---|
| 4 | Maximal volume concentration of solid | %30-20 |
| | particles (sediment of treatment of sewage | |
| | municipal water) in water suspension | |

| | | |
|---|---|---|
| 5 | Mass concentration of dry solid | %5 |
| | particles | |
| 6 | density of solid particles | 1075-1300 kg/m3, |
| 7 | linear sizes | 50 mkm-20 mm |
| 8 | heat value | 3500-5000 kcal/kg |
| 9 | ash | 9-25%,, |
| 10 | sulfur | 0.7-0.9%, |
| 11 | flying components | 50-65%, |
| 12 | wetness | 90-97% |
| 13 | Specific resistance of sewage | 500-50 × 10⁻¹⁰ cm/g |
| | sludge | |

### REFERENCES

1. M. Sami, K. Annamalai, M. Wooldridge, “Cofiring of coal and biomass fuel blends”, Progress in Energy and Combustion Science, 27, 171-214, 2001
2. Williams, R. “Sewage sludge disposal apparat. & method of disposal”, U.S. Pat. No. 4,245,570, 1981
3. Krivohlavek D. “Multiple phase emulsions in burner fuel, combustion, emulsion and explosives applications”, U.S. Pat. No. 5,834,539, 1998
4. Dijkman, B. and Geurts, M. J. G., “Testing co-combustion of sewage sludge in a 630 MW coal-fired block at Hemweg Amsterdam Netherlands”, Proc. AIM Inter. Conf. on Power Stations, Liege, Belgium, 13-15 Oct., 1997.
5. Buzukov A. A. “Autoignition and combustion of water-fuel emulsion”, Physics of Combustion and Explosion”, v. 31, N. 5, pp. 3-11, 1995
6. WRc/W. S. Atkins, Incineration of Sewage Sludge, 1985
7. J. E. Shepherd, “Rapid Evapor. at the superheat limit”, J. Fluid Mech., 121, 379-402, 1982
8. N. J. Marrone, I. M. Kennedy and F. L. Dryer, Short Communication: “Internal Phase Size Effects on Combustion of Emulsions”, Combustion Science and Technology, 33, 299-307, 1983
9. Bianco Y., Cheng W. K. and Heywood J. B. Combustion flame, 110, 1646-1652, 1990
10. T. X. Li, D. L. Zhu and C. K. Law, “Journal of Propulsion & Power”, vol. 14, No. 1. 45-50, 1998
11. A. Ya. Isakov “Some features of micro explosion of a drop of water-fuel emulsion”, Fizika Goreniya I Vzryva, vol. 21, No. 1, pp. 125-126, 1985
12. Lozitsky N. G. and Kotler K. T. Using of burners with rotate atomizer for burning of oil with water adds”. Promyshlennaya Energetika, Moscow, No. 3, 2002
13. Yoshiro Kitamura, Qingfa Huang, Yasuhiro Oka and Teruo Takahashi, “Flashing of superheated water-in oil emulsions -micro-explosion of emulsified fuels”, Journal of Chemical Engineering of Japan, vol 23, No 6, pp 711-715 (1990)
14. G. Borodyanski and V. Afanasyev, “The arc discharge device working on the electro-hydraulically effect”, Patent USSR, No. 680515
15. Fedotkin I. M., Guly S. I., “Cavitation and cavitation apparatuses”, Kiev, 1998
16. J. A. Wunning, J. G. Wunning, “Flameless oxidation to reduce thermal NO formation”, Progress in Energy and Combustion Science”, 23, pp. 81-94, 1995
17. “Handbook on purification of natural and sewage waters”, M., pp. 336, 1994
18.
19. O. Sotolonga-Costa, Y. Moreno-Vega, J. Lioveras-Gonzales, J. Antoranz, “Criticality in Droplet Fragmentation”, Physical Review Letters, V. 76, N. 1, pp. 42-45, 1996
20. Borodyanski G., Chudnovsky B., et al. “NOx and CO₂ emissions reduction when reformed fuel burning”. “Comb. and Emission Control”. Institute of Energy, London., pp. 157-172, (1997).
21. Borodyanski G. and Konstantinov I., “Microalgae Separator. Apparatus and Method”, U.S. Pat. No. 6,524,486, 25.02. (2003).
22. Borodyanski G., Yantovski E., Levin L., “Power Plant with CO2-capture and solar energy conversion in microalgae mass culture”, Proceeding of the 27-th Israel Conference on Mechanical Engineering, pp. 589-591, Technion City, Haifa, May (1998).

1. An apparatus for burning sewage sludge using supplementary fuel comprising:
sewage sludge supply module;
fuel supply module;
mixer adapted to receive the sewage sludge from said sewage sludge module and fuel from said fuel supply module and form a mixture;
combustion module adapted to receive said mixture and form combustion.

2. An apparatus as claimed in claim 1, wherein the fuel is coal in pulverized form.

3. An apparatus as claimed in claim 1, wherein the fuel is mazut in an atomizied form.

4. An apparatus as claimed in claim 1, incorporated within a power generation plant wherein energy is generated from said combustion module.

5. An apparatus as claimed in claim 1, wherein the fuel is liquid fuel such as mazut that is used in a form of fuel emulsion wherein said fuel emulsion is prepared in a gas turbine.

6. An apparatus as claimed in claim 1, wherein the fuel is solid fuel such as coal or slurry that is used in its grinded form wherein said coal or slurry is grinded into powder with maximal sizes less 100 mkm that is used to prepare fuel suspension in a steam turbine.

7. An apparatus as claimed in claim 1, further provided with plastificator from which elulsifying agents are delivered to said mixer.

8. An apparatus as claimed in claim 1, wherein the sewage sludge comprises insoluble organic minerals, water, and solid components.

9. An apparatus as claimed in claim 1, wherein the sewage sludge is delivered to said mixer through an ejector dozator.

10. An apparatus as claimed in claim 1, wherein the fuel is delivered to said mixer through an ejector dozator.

11. An apparatus as claimed in claim 1, wherein siad combustion module is provided with a filter adapted to filter exhaust gas.

12. An apparatus as claimed in claim 1, wherein air compressor is provided adapted to compress air to said combustion module or to an ejector dozator that doze the fuel.

13. The apparatus as claimed in claim 1, wherein said combustion module comprising gas turbine and furnace of steam boiler in seam turbine.

14. The apparatus as claimed in claim 1, wherein said sewage sludge module and said fuel module are subsequent arranged and connected by conduit for pumping and dosing the fuel and the sewage sludge into siad mixer and wherein each of said sewage sludge module and said fuel module comprises an ejector and control valve as well as pumping modules connected by conduit perpendicular to an axis of the ejectors that are connected to the according modules.

15. The apparatus as claimed in claim 1, further comprising atomizer through which said mixture is delivered to said combustion module, wherein said atomizer is provided with rotate pulverizing part to avoid slogging by solid particles inherent in the sewage sludge.

16. The apparatus as claimed in claim 1, further comprising a block of cleaning combustion products for increasing power plant capacity when oxygen enriches and NOx-reduces and obtaining CO2 that is used as gas-ballast in said combustion module.

17. The apparatus as claimed in claim 16, wherein said block of cleaning combustion products comprises water cooler connected to the block with thermal power station along stack gas side.

18. The apparatus as claimed in claim 16, wherein said block of cleaning combustion products comprises bubble column filled with water to separate SO₂ from flue gas.

19. The apparatus as claimed in claim 18, wherein said block of cleaning combustion products comprises thermal SO₂-degasator hydraulically coupled with said bubble column and said thermal SO₂-degasator supplied by heater for heating water by hot flue gas before entring into said cooler.

20. The apparatus as claimed in claim 16, wherein said block of cleaning combustion products comprises bubble column filled with water to separate CO₂ from flue gas.

21. The apparatus as claimed in claim 20, wherein said block of cleaning combustion products comprises thermal CO₂-degasator coupled with said bubble column and said thermal CO₂-degasator supplied by heater for heating of water by hot flue gas before entring into said cooler.

22. The apparatus as claimed in claim 21, wherein said block of cleaning combustion products comprises an exit in which gas space of the thermal CO₂-degasator is connected with an entrance to said combustion module.

23. A method for burning sewage sludge comprising:
dispersing said sewage sludge into finely pulverized sewage sludge form in a mixer;
mixing said finely pulverized sewage sludge with fuel into a mixture;
adding plastificator into said mixture to form a stable mix;
introducing said stable mix into a combustion module;
burning said stable mix in said combustion module.

24. The method as claimed in claim 23, further comprising generating power from said said combustion module.

25. The method as claimed in claim 23, wherein said combustion module comprising gas turbine and furnace of steam boiler in seam turbine.

26. The method as claimed in claim 23, wherein the sewage sludge is used in simple cycles of thermal power generation.

27. The method as claimed in claim 23, wherein the sewage sludge is used in combine cycles of thermal power generation.

28. The method as claimed in claim 23, further comprising pumping primary air necessary to burn the sewage sludge into said fuel and pumping secondary air into said combustion module.

29. The method as claimed in claim 23, further comprising selecting the sewage sludge to fuel ratio to be not more than 0.5.

30. The method as claimed in claim 29, further comprising refining the ratio between sewage sludge and fuel in accordance with demand of NOx-reducing up to level less than 10 ppm under simultanuos providing stable combustion between 100% to 30% load.

31. The method as claimed in claim 23, further comprising providing atomizer that introduces sad stable mix into said combustion module, wherein said atomizer is provided with rotate pulverizing part to avoid slogging by solid particles inherent in the sewage sludge.

32. The method as claimed in claim 23, further comprising impriving the stability of combustion by oxygen enrichment through membrane gas generator that is adapted to connect an exhaust gas outlet with an entrance of siad combustion module.

33. The method as claimed in claim 23, further comprising simultaneously improving stability of suspension or emulsion that is delivered into said combustion module.

34. The method as claimed in claim 23, further comprising providing block of cleaning combustion products for increasing power plant capacity when oxygen enriches and NOx-reduces, and obtaining CO2 that is used as gas-ballast in said combustion module from siad block of cleaning combustion products.

35. The method as claimed in claim 34, wherein said block of cleaning combustion products comprises water cooler connected to the block with thermal power station along stack gas side.

36. The method as claimed in claim 34, wherein said block of cleaning combustion products comprises bubble column filled with water to separate SO₂ from flue gas.

37. The method as claimed in claim 36, wherein said block of cleaning combustion products comprises thermal SO₂-degasator hydraulically coupled with said bubble column and said thermal SO₂-degasator supplied by heater for heating water by hot flue gas before entring into said cooler.

37. The method as claimed in claim 34, wherein said block of cleaning combustion products comprises bubble column filled with water to separate CO₂ from flue gas.

38. The method as claimed in claim 37, wherein said block of cleaning combustion products comprises thermal CO₂-degasator coupled with said bubble column and said thermal CO₂-degasator supplied by heater for heating of water by hot flue gas before entring into said cooler.

39. The method as claimed in claim 34, wherein said block of cleaning combustion products comprises an exit in which gas space of the thermal CO₂-degasator is connected with an entrance to said combustion module.
